(19) United States
(12) Patent Application Publication
(10) Pub. No.: US 2016/0243880 A1
(43) Pub. Date: Aug. 25, 2016

(54) Magnetic Calendar System and Paper Calendar with Dry Erase Surface

(71) Applicant: Ronald Bianco, Laguna Beach, CA (US)

(72) Inventor: Ronald Bianco, Laguna Beach, CA (US)

(21) Appl. No.: 14/628,162

(22) Filed: Feb. 20, 2015

(51) Int. Cl. B43L 12/02; G09B 19/00

(52) U.S. Cl. CPC B43L 12/02; G09B 19/00

(57) ABSTRACT

A magnetic calendar storage system is provided that includes a calendar support having a magnetic insert within the calendar support, a hinged magnetic board secured to the calendar support, and a transparent, hinged, dry erase sheet secured to the calendar support, permitting a user to hang a paper calendar on the calendar support and interleave both the hinged magnetic board and the dry erase sheet between pages of the paper calendar.

### BACKGROUND

The present invention relates to a system for facilitating use of paper calendars for recording information the user wishes to preserve long term while enjoying the benefits of a dry erase surface that permit the recording of information that the user does not wish to preserve long term.

The popularity of paper based calendars has not diminished in favor of electronic alternatives. The calendar remains a focal point in many households and can show the schedules, appointment and other important information for multiple family members. Most calendars can be used for recording permanent records and archives of important events or milestones. Also sometimes more temporary information is stored there and then is difficult to remove or erase. The dry erase calendar has grown in popularity but unfortunately it is not useful for permanent information, archive or milestone, such as birthdays and anniversaries. Combination calendars with a dry erase component are available but they can be expensive and large in size. For many families or offices, wall space can be a premium. It would therefore be an advantage to create an inexpensive space saving alternative.

### SUMMARY

With certain embodiment of the present invention, a magnetic calendar storage system is provided for facilitating the use of a paper calendar suspended in a vertical orientation. In some embodiments, the system comprises a calendar support comprising a generally flat base upon which a paper calendar may be applied, where the calendar support further comprises a first magnetic insert positioned within the calendar support such that it may be, but does not have to be, directly behind a paper calendar if the paper calendar is applied to the calendar support. With such embodiments, the system further comprises a hinged magnetic board secured to the calendar support and positioned so that it may be selectively interleaved between pages of a paper calendar if the paper calendar is applied to the calendar support. Moreover, a transparent, hinged, dry erase sheet is also provided secured to the calendar support and positioned so that it may be placed on top of a paper calendar if the paper calendar is applied to the calendar support.

With such embodiments, as with others contemplated herein, a user of the magnetic calendar storage system may apply a paper calendar to the calendar support and selectively interleave the hinged magnetic board in between pages of the paper calendar in a manner such that the hinged magnetic board is magnetically drawn to the first magnetic insert of the calendar support thereby tightly securing some of the pages of the paper calendar between the hinged magnetic board and the first magnetic insert leaving at least one of the pages of the paper calendar exposed. If desired, the user can then close the transparent, hinged, dry erase sheet over top of the exposed page of the paper calendar so that the page is visible to the user, and wherein the user can then elect to either write with a dry erase marker directly onto the transparent, hinged, dry erase sheet over top the exposed page or temporarily lift the transparent, hinged, dry erase sheet and write directly onto the exposed page of the paper calendar in a more permanent manner.

In some embodiments, the magnetic calendar storage system further includes one or more versions of a paper calendar, where it is configured to be applied to the calendar support in such a manner that the system can be suspended vertically to permit use of the calendar by the user in a vertical orientation. In one or more embodiments, the first magnetic insert comprises a plurality of magnets.

In some embodiments, the transparent, hinged, dry erase sheet is secured to the calendar support by way of a mechanical support that permits hinged movement of the transparent, hinged, dry erase sheet relative to the calendar support. A second mechanical support may be used to secure the hinged magnetic board to the calendar support in a similar or different manner as the transparent, hinged, dry erase sheet. Either mechanical support may comprise a hinge configured to permit the user to close the transparent, hinged, dry erase sheet or the hinged magnetic board over a page of the paper calendar without need of bending the transparent, hinged, dry erase sheet or the hinged magnetic board. That may be advantageous when using a hinged magnetic board that is not as flexible as a transparent, hinged, dry erase sheet.

In other embodiments of calendar systems contemplated herein, a magnetic calendar system is provided similar to those described above but without a transparent, hinged, dry erase sheet provided. In such alternative embodiments, a paper calendar may be provided for use with such calendar systems in which the paper calendar comprises a ring-bound paper calendar along with a transparent dry erase sheet detachably coupled to the paper calendar by way of a ring binding mechanism integrating the individual pages of the ring-bound paper calendar together. Examples of the types of ring binding contemplated include twin wire binding, wire-o™ binding, or spiral binding, as well as others.

With such paper calendar embodiments, each paper calendar sheet can be exposed by flipping the sheets or pages above it out of the way using the ring binding mechanism to keep the pages integrated into the calendar. Additionally, the transparent dry erase sheet is configured such that, when detachably coupled to the paper calendar, the dry erase sheet can be positioned on top of an exposed paper calendar sheet to permit a user to view the top paper calendar sheet through the transparent dry erase sheet. With such arrangements, the user may write directly onto the exposed paper calendar sheet in a permanent manner, and write on the transparent dry erase sheet in a semi-permanent manner.

In some embodiments, the transparent dry erase sheet is detachably coupled to the paper calendar by way of a plurality of tabs that are configured to engage the ring binding mechanism, permitting the transparent dry erase sheet to be moved away from the exposed paper calendar sheet or to be moved onto top of the exposed paper calendar sheet while remaining coupled to the ring binding mechanism. Such tabs may be configured as one or more of a number of possible geometric configurations, each sufficiently flexible to fit between two adjacent rings in the ring binding mechanism while sturdy enough to permit a user to rotate the transparent dry-erase sheet without it too easily detaching from the ring binding mechanism.

### BRIEF DESCRIPTION OF THE FIGURES

The aforementioned objects and advantages of the present invention, as well as additional objects and advantages thereof, will be more fully understood hereinafter as a result of a detailed description of a preferred embodiment when taken in conjunction with the following drawings in which:

FIG. 1 shows a top schematic view of one embodiment of the present invention;

FIG. 2 shows the embodiment of FIG. 1 in a first position;

FIG. 3 shows the embodiment of FIG. 1 in a second position along with an optional paper calendar;

FIG. 4 shows the embodiment of FIG. 1 in a third position;

FIG. 5 shows the embodiment of FIG. 1 in a fourth position;

FIG. 6 shows a top schematic view of an alternative embodiment of the present invention;

FIG. 7 shows a top schematic view of a paper calendar system that can be used in association with calendar system embodiments such as that shown in FIG. 6;

FIG. 8 shows additional details of the paper calendar system of FIG. 7;

FIGS. 9A and 9B show additional alternative details of the paper calendar system of FIG. 7.

### DETAILED DESCRIPTION OF CERTAIN EMBODIMENTS

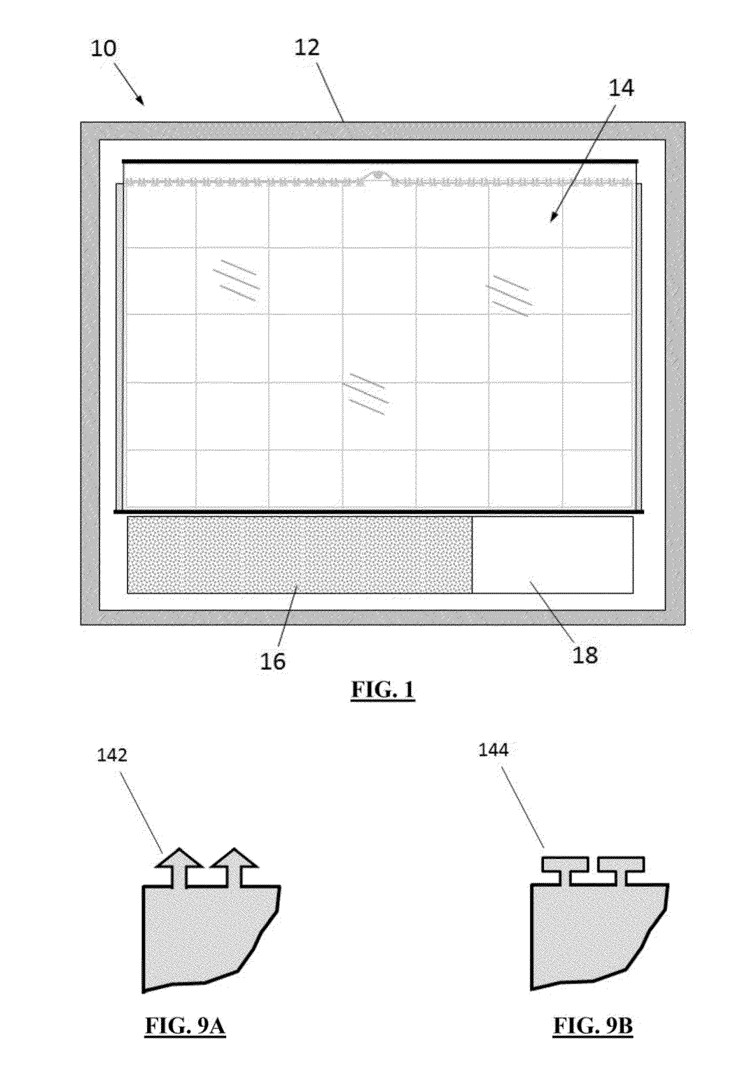

By way of example, and referring to FIG. 1, one embodiment of the present invention can be described. In one such embodiment, a magnetic calendar storage system 10 is provided for facilitating the use of a paper calendar suspended in a vertical orientation. Embodiments of magnetic calendar storage system 10 comprise a calendar support 12 and a calendar system 14. Optionally, one or more accessory placement areas may be provided on the magnetic calendar storage system 10, including an optional cork board 16 and an optional magnetic board 18.

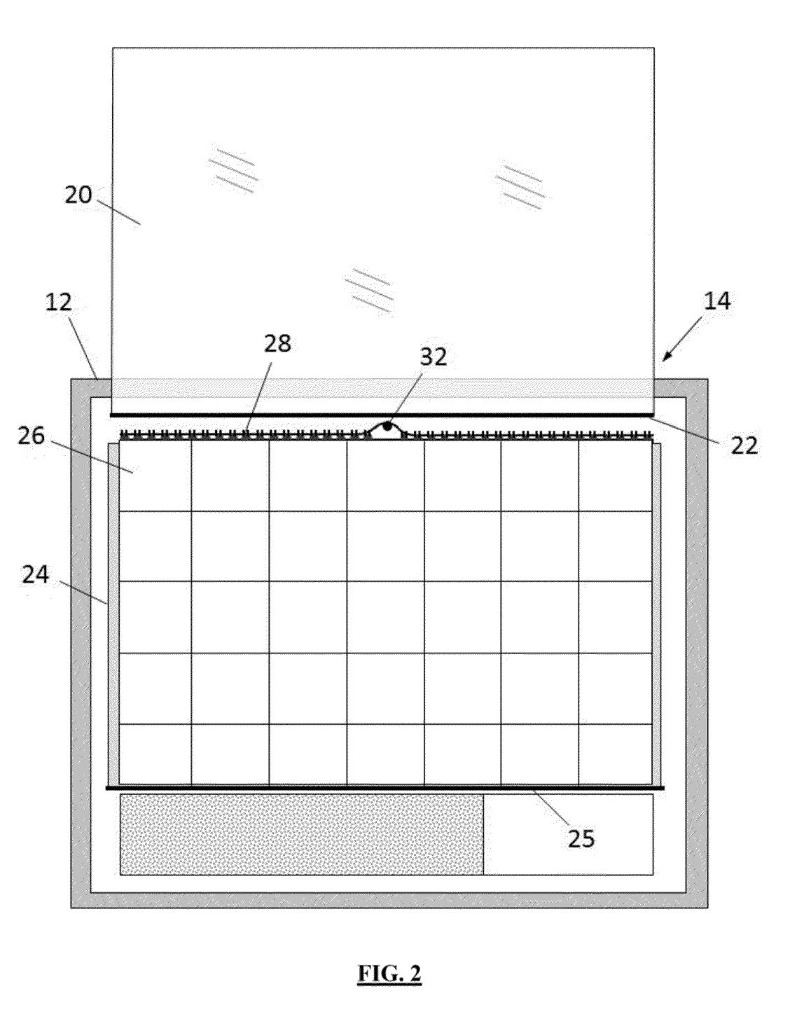

Referring to FIGS. 2-5, the calendar system 14 comprises a transparent, hinged, dry erase sheet 20 secured to the calendar support 12. The transparent, hinged, dry erase sheet 20 may be flexible and pliable so that it may bend, or may be more rigid and not so easily bent. If desired, the dry erase sheet 20 may be secured to the calendar support 12 using a first mechanical support 22, where it is desired to space the dry erase sheet 20 from the calendar support 12. The first mechanical support 22 may comprise a spacing member or may comprise a hinge, depending upon whether the dry erase sheet 20 is bendable or not. Either way, it is not critical to the functionality desired of permitting the dry erase sheet 20 to be lifted upwardly or downwardly to expose or cover what is on the calendar support.

Embodiments of the magnetic calendar storage system 10 may also comprise a hinged magnetic board 24 secured to the calendar support 12. As with the dry erase sheet 20, the magnetic board 24 may be flexible and pliable so that it may bend, or may be more rigid and not so easily bent. If desired, the magnetic board 24 may be secured to the calendar support 12 using a second mechanical support 25, where it is desired to space the magnetic board 24 from the calendar support 12. The second mechanical support 25 may comprise a spacing member or may comprise a hinge, depending upon whether the magnetic board 24 is bendable or not. Either way, it is not critical to the functionality desired of permitting the magnetic board 24 to be lifted upwardly or downwardly to expose or cover what is on the calendar support.

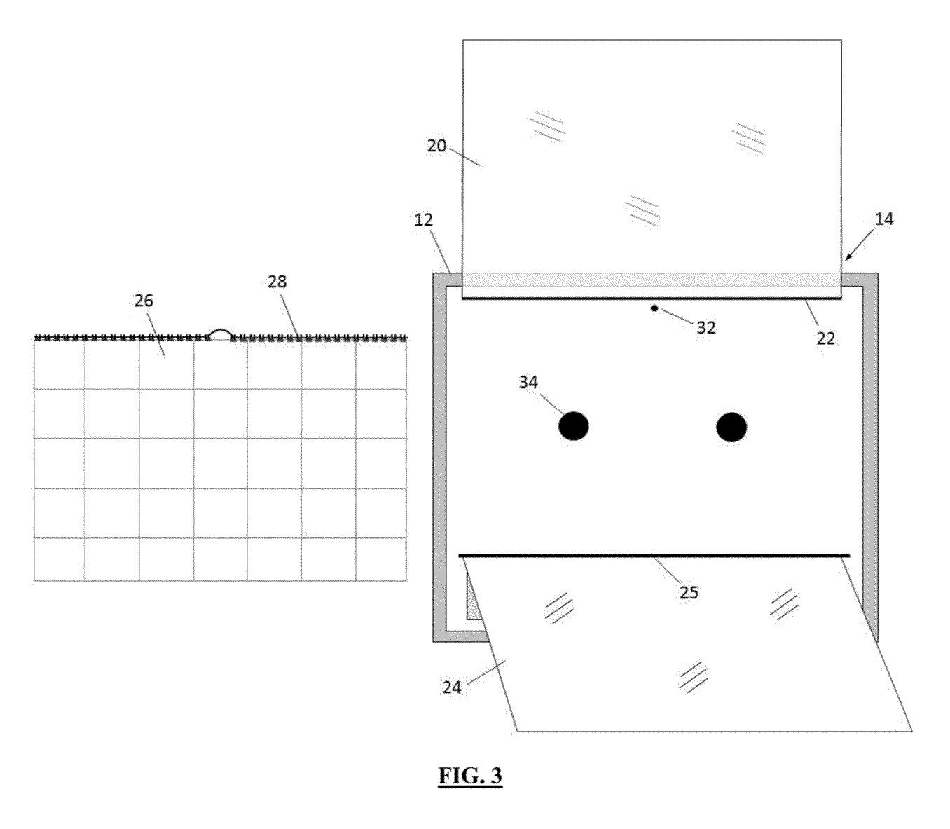

Embodiments of the magnetic calendar storage system 10 may also comprise a ring-bound paper calendar system comprising a paper calendar 26 comprising a plurality of calendar pages integrated with a ring binding mechanism 28 that may be suspended from a hook 32 provided on the calendar support 12. As may be appreciated with particular reference to FIG. 3, the ring-bound paper calendar system is removable. As shown in FIG. 3, a magnetic insert 34 is provided on the calendar support 12. The magnetic insert 34 may comprise a single insert, or it may comprise multiple inserts, and may also comprise one or more shapes and sizes. In one embodiment, such as that shown in FIG. 3, the magnetic insert 34 comprises two magnets, each positioned behind where the paper calendar 26 would be if it were applied to the calendar support 12. In other embodiments, it is contemplated that at least one magnet could be positioned outside the area in which the paper calendar 26 would reside. While rare-earth metals are preferred for use as a magnetic insert, other materials may be employed that exhibit sufficient magnetic fields, with the intent of securing the face of magnetic board 24 to the calendar support 12, with or without paper calendar pages therebetween.

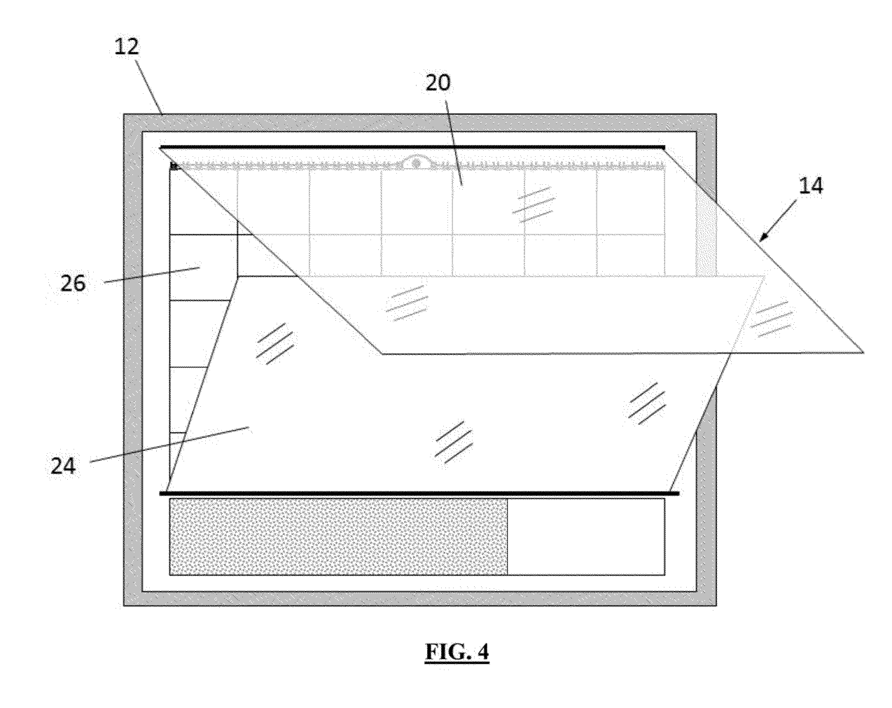

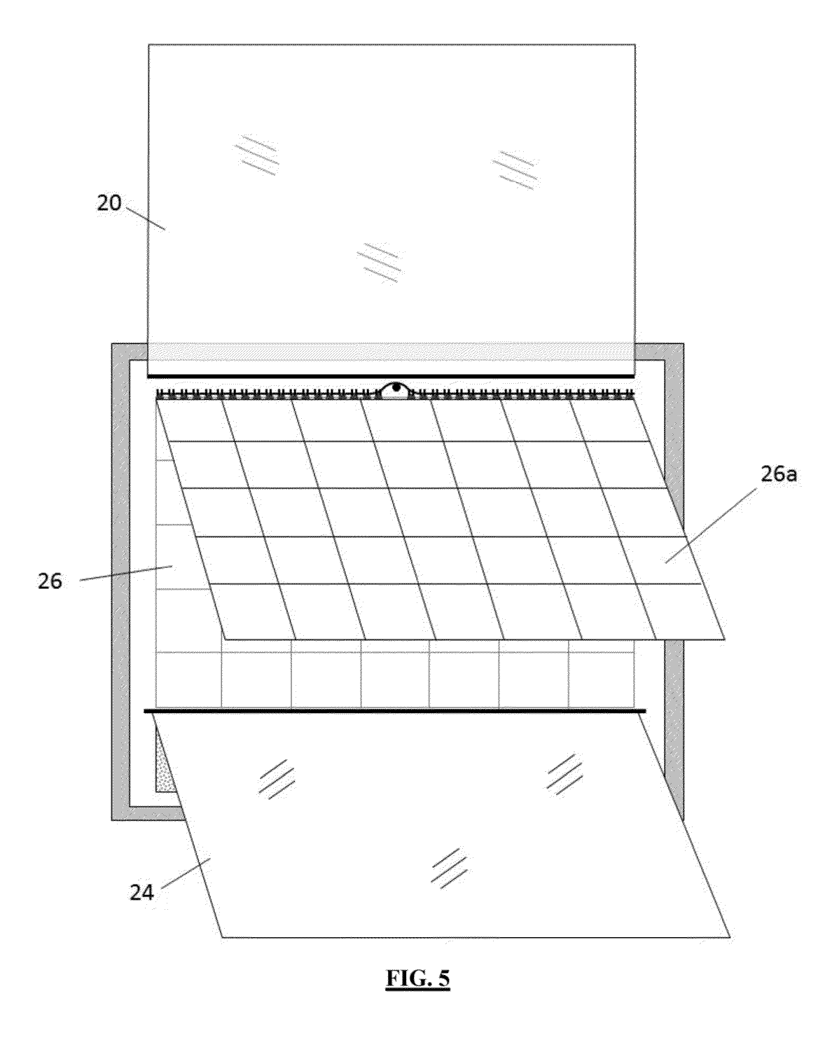

With reference to FIGS. 4 and 5, one can appreciated that once applied to the calendar support 12, pages of the paper calendar 26 can be lifted upwardly to interleave the magnetic board 24 between adjoining pages. In one application, the user takes the paper calendar 26, flips behind the calendar pages that the user is not interested in seeing, and exposes a desired calendar page 26a. That page 26a can be lifted enough to position the magnetic board 24 between it and the page behind it. The magnetic connection between the magnetic inserts 34 and the magnetic board secures the back pages of the calendar securely in place, leaving the exposed calendar page 26a visible to the user. The transparent dry erase sheet 20 may then be positioned on top of the calendar page 26a, leaving the system as shown in FIG. 1. With this arrangement, the user may then use a dry erase marker to semi-permanently write on the dry erase sheet 20 to make notes commensurate with days of the week as seen through the transparent sheet 20. If desired, the user may lift momentarily the dry erase sheet 20 so make more permanent notes directly onto the calendar page 26a.

In some embodiments, as shown in FIGS. 1-6, by example only, the transparent, hinged, dry erase sheet is positioned above the area where a paper calendar may be secured to the calendar support, while the hinged magnetic board is positioned below the area where a paper calendar may be secured to the calendar support. There is some advantage to this configuration because the hinged magnetic board (from below) would have a tendency to fall back downwardly away from a paper calendar except that the magnetic insert will keep it secured in place, while it is desirable to have the transparent, hinged, dry erase sheet lying flat atop a paper calendar suspended from above. However, it may be that a user desires the relative positions of both to be reversed. Or it may be desired, as another example, that the hinged magnetic board swing upwardly from below and the transparent, hinged, dry erase sheet swing sidewise into place from a left or right position relative to a paper calendar. In that arrangement, the hinged dry erase sheet is positioned orthogonally at a right angle to the hinged magnetic board. The gravity effects on either of the transparent, hinged, dry erase sheet and the hinged magnetic board of course is removed if the user intends to use the calendar systems on a horizontal flat surface rather than suspended from a vertical wall or door.

With some embodiments, the magnetic calendar storage system may include comprising one or more accessory placement areas secured to the calendar support such as to remain visible to a user even if a paper calendar is applied to the calendar support. One such accessory placement area may comprise a cork board. Another may comprise a second magnetic insert on which a user may store magnetic accessories that could be used to be placed on top of the paper calendar or on top of the transparent, hinged, dry erase sheet when in use, where such magnetic accessory is affixed in place by the first magnetic insert behind the paper calendar. It is important to note, however, that an optional magnetic accessory placement area need not be provided while still permitting the user to apply magnetic accessories atop the visible paper calendar page or atop the dry erase sheet positioned atop the visible paper calendar page.

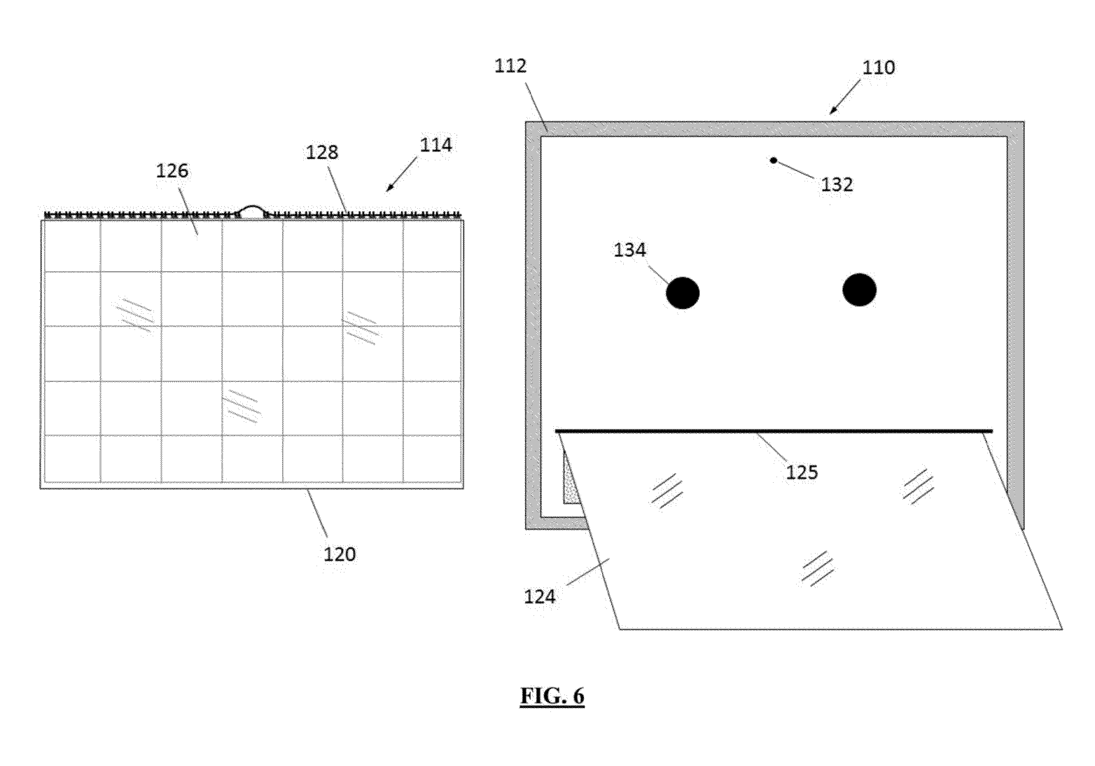

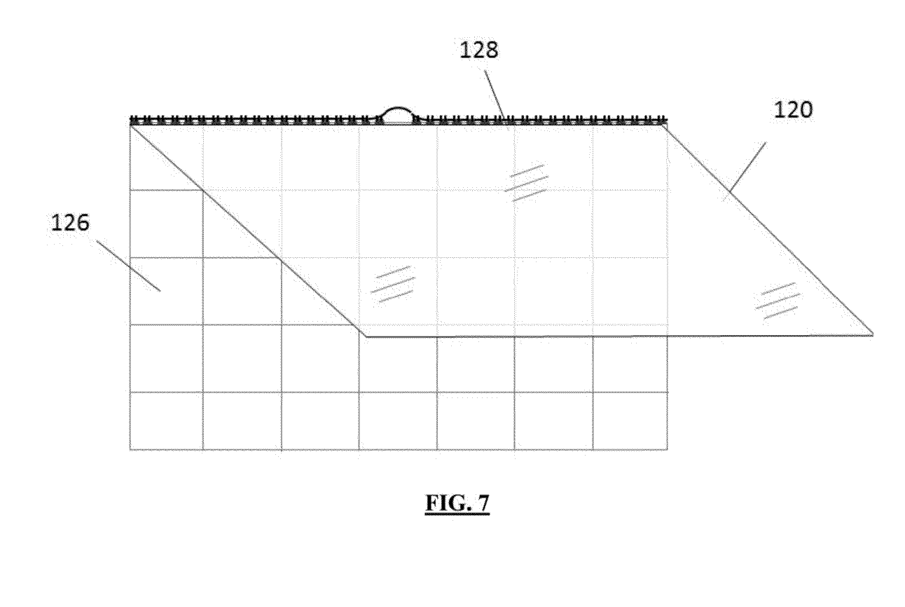

It is contemplated herein that an alternative paper calendar system 110 may be provided where such systems include a dry erase sheet as part of the calendar, thereby eliminating the need for the transparent dry erase sheet provided on the magnetic calendar storage system. In that regard, reference is made to FIGS. 6 and 7 where an alternative system 110 is shown comprising a calendar support 112 with a hinged magnetic board 124 supported with or without a mechanical support 125, where the calendar support also includes a hook 132 and a magnetic insert 134. A paper calendar system 114 is also provided that comprises a paper calendar 126 containing pages integrated using a ring binding mechanism 128, where the paper calendar system 114 is also provided with a transparent dry erase sheet 120. With this arrangement, the magnetic calendar storage system 110 need not include an integrated transparent, hinged, dry erase sheet, as with the embodiments described above. The paper calendar system 114 with integrated dry erase sheet 120 can be supported on the calendar support 112 using the hook 132 such that the dry erase sheet 120 can be used similarly as described above. Likewise, the user may interleave the magnetic board 124 between pages of the paper calendar 126.

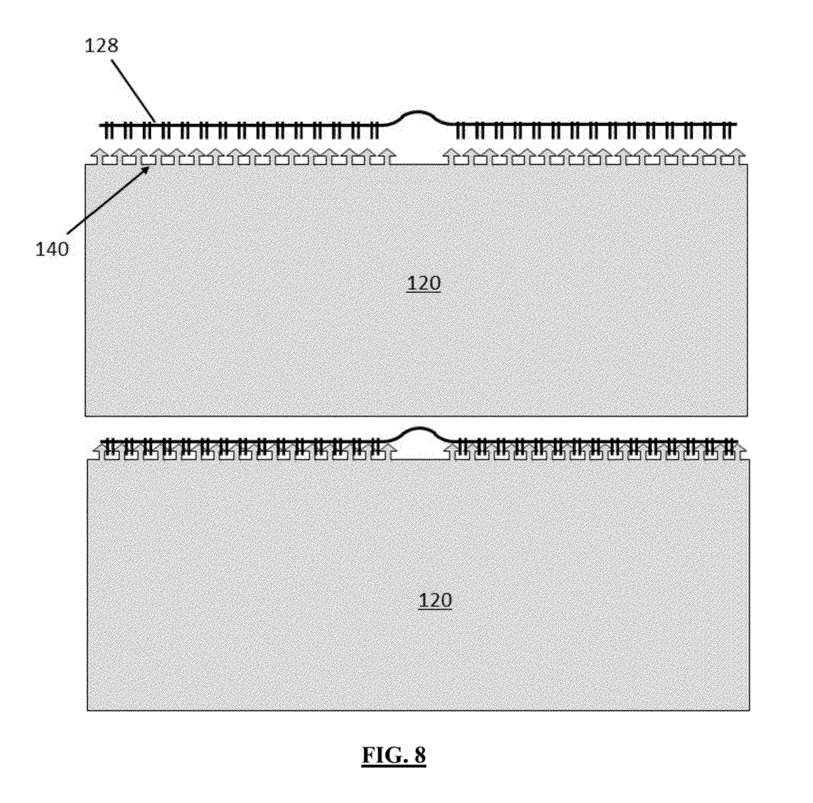

To maximize effective use, however, it is desirable that the dry erase sheet 120 be detachably coupled to the ring binding mechanism 128 so that it can be placed atop the calendar page that the user desires be visible when suspended on the calendar support 112. In that regard, a feature is provided on the transparent dry erase sheet 120 that permits detachable coupling. Specifically, referring to FIGS. 8 and 9, the dry erase sheet 120 comprises a plurality of tabs 140 arranged across one side of the dry erase sheet 120 so as to detachably couple to the ring binding mechanism 128. The tabs 140 may be triangular in shape (e.g., such as in the configuration of an arrow) or T-shaped, among other possible shapes. The material of the dry erase sheet 120 is also preferably sturdy and at least sufficiently bendable that each tab may be user-positioned between two adjacent rings on the ring binding mechanism 128 to permit the dry erase sheet 120 to be turned as a page in the calendar 126 without so easily becoming detached from the paper calendar system 114. This allows the user to interleave the dry erase sheet 120 in between any two adjacent calendar pages as desired. The result is that the user can interleave both the dry erase sheet 120 and the magnetic board 124 to permit use such as that described above in association with the embodiment of FIG. 5. With this arrangement, the user may then use a dry erase marker to semi-permanently write on the dry erase sheet 120 to make notes commensurate with days of the week as seen through the transparent sheet 120. If desired, the user may lift momentarily the dry erase sheet 120 so make more permanent notes directly onto the page of the paper calendar 126.

It is important to note that an embodiment of paper calendar system 114 with detachably coupled transparent dry erase sheet 120 may be used without a calendar support structure 112, as described above, but rather used in a self-standing manner. The magnetic feature, of course, is not part of the paper calendar system 114 in such circumstances. However, it is further contemplated that such systems may be made further self-standing and include a magnetic feature by providing a detachably coupled magnetic board (not shown) to the paper calendar system 114, in a manner the same or similar to that provided for the detachably coupled transparent dry erase sheet 120, in which a plurality of tabs are provided to be inserted between adjacent ring of the ring binding mechanism. Like the detachably coupled transparent dry erase sheet 120, the detachably coupled transparent magnetic board could be coupled to the ring binding mechanism between two adjacent paper calendar pages. The detachably coupled transparent dry erase sheet 120 could then be coupled to the ring binding mechanism at a different place in the paper calendar; i.e., between two other adjacent calendar pages, so that the calendar may be used in a manner described above for permanent and semi-permanent recording of information. For horizontal use, the weight of the magnetic board serves to keep the paper calendar pages not in use securely in place. For vertical use, the paper calendar system could be secured to a vertical ferrous surface to which the magnetic board would be drawn to support the paper calendar system in place and, at the same time, keep the paper calendar pages not in use securely in place as well.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A magnetic calendar storage system for facilitating the use of a paper calendar suspended in a vertical orientation, the system comprising:
a calendar support comprising a generally flat base upon which a paper calendar may be applied, the calendar support further comprising a first magnetic insert positioned within the calendar support;
a hinged magnetic board secured to the calendar support and positioned so that it may be selectively interleaved between pages of a paper calendar if the paper calendar is applied to the calendar support; and
a transparent, hinged, dry erase sheet secured to the calendar support and positioned so that it may be placed on top of a paper calendar if the paper calendar is applied to the calendar support,
wherein a user of the magnetic calendar storage system may apply a paper calendar to the calendar support and selectively interleave the hinged magnetic board in between pages of the paper calendar in a manner such that the hinged magnetic board is magnetically drawn to the first magnetic insert of the calendar support thereby tightly securing some of the pages of the paper calendar between the hinged magnetic board and the first magnetic insert leaving at least one of the pages of the paper calendar exposed, and wherein the user can then close the transparent, hinged, dry erase sheet over top of the exposed page of the paper calendar so that the page is visible to the user, and wherein the user can then elect to either write with a dry erase marker directly onto the transparent, hinged, dry erase sheet over top the expose page or temporarily lift the transparent, hinged, dry erase sheet and write directly onto the exposed page of the paper calendar.

2. The magnetic calendar storage system of claim 1, further comprising a paper calendar configured to be applied to the calendar support in such a manner that the system can be suspended vertically to permit use of the calendar by the user in a vertical orientation.

3. The magnetic calendar storage system of claim 1, wherein the first magnetic insert comprises a plurality of magnets.

4. The magnetic calendar storage system of claim 1, further comprising one or more accessory placement areas secured to the calendar support such as to remain visible to a user even if a paper calendar is applied to the calendar support.

5. The magnetic calendar storage system of claim 4, wherein one accessory placement area comprises a cork board.

6. The magnetic calendar storage system of claim 4, wherein one accessory placement area comprises a second magnetic insert on which a user may store magnetic accessories that could be used to be placed on top of the paper calendar or transparent, hinged, dry erase sheet when in use, where such magnetic accessory is affixed in place by the first magnetic insert behind the paper calendar.

7. The magnetic calendar storage system of claim 1, wherein the transparent, hinged, dry erase sheet is secured to the calendar support by way of a first mechanical support that permits hinged movement of the transparent, hinged, dry erase sheet relative to the calendar support.

8. The magnetic calendar storage system of claim 7, wherein the first mechanical support comprises a hinge configured to permit the user to close the transparent, hinged, dry erase sheet over an exposed page of the paper calendar without need of bending the transparent, hinged, dry erase sheet.

9. The magnetic calendar storage system of claim 7, wherein the hinged magnetic board is secured to the calendar support by way of a second mechanical support that permits hinged movement of the hinged magnetic board relative to the calendar support.

10. The magnetic calendar storage system of claim 9, wherein the second mechanical support comprises a hinge configured to permit the user to close the hinged magnetic board over an exposed page of the paper calendar without need of bending the hinged magnetic board.

11. The magnetic calendar storage system of claim 9, wherein the first mechanical support is generally parallel to the second mechanical support.

12. The magnetic calendar storage system of claim 1, further comprising the calendar system of claim 14.

13. The magnetic calendar storage system of claim 1, wherein the first magnetic insert is positioned such that it is directly behind where a paper calendar would be if the paper calendar were applied to the calendar support.

14. A calendar system configured for semi-permanent and permanent recording of information and events, the system comprising:
a ring-bound paper calendar comprising a plurality of paper calendar sheets secured to a ring binding mechanism, the paper calendar configured such that each paper calendar sheet can be exposed by flipping the sheets above it out of the way using the ring binding mechanism, and
a transparent dry erase sheet detachably coupled to the calendar, the transparent dry erase sheet configured, when detachably coupled to the paper calendar, such that the dry erase sheet can be placed on top of an exposed paper calendar sheet to permit a user to view the paper calendar sheet below the transparent dry erase sheet,
wherein the user may write directly onto the exposed paper calendar sheet in a permanent manner, and write on the transparent dry erase sheet in a semi-permanent manner.

15. The calendar system of claim 14, wherein the transparent dry erase sheet is detachably coupled to the calendar by way of a plurality of tabs the are configured to engage the ring binding mechanism, permitting the transparent dry erase sheet to be moved away from the exposed paper calendar sheet or to be moved onto top of the exposed paper calendar sheet while remaining coupled to the ring binding mechanism.

16. The calendar system of claim 14, wherein the tabs are configured in a geometric configuration sufficiently flexible to fit between two adjacent rings in the ring binding mechanism while sturdy enough to permit a user to rotate the transparent dry-erase sheet without it too easily detaching from the ring binding mechanism.

17. The calendar system of claim 14, further comprising a magnetic board detachably coupled to the calendar so that the magnetic board may be detachably coupled to the calendar between two adjacent paper calendar sheets while the transparent dry erase sheet may be detachably coupled to the calendar between two other adjacent paper calendar sheets.

18. A magnetic calendar storage system for facilitating the use of a paper calendar suspended in a vertical orientation, the system comprising:
a calendar support comprising a generally flat base upon which a paper calendar may be applied, the calendar support further comprising a first magnetic insert positioned within the calendar support; and
a hinged magnetic board secured to the calendar support and positioned so that it may be selectively interleaved between pages of a paper calendar if the paper calendar is applied to the calendar support.

19. The magnetic calendar storage system of claim 18, further comprising a paper calendar system comprising a ring-bound paper calendar and a transparent dry erase sheet detachably coupled to the paper calendar, paper calendar system configured to be applied to the calendar support in such a manner that the system can be suspended vertically to permit use of the calendar by the user in a vertical orientation, wherein a user of the magnetic calendar storage system may selectively interleave the hinged magnetic board in between pages of the paper calendar in a manner such that the hinged magnetic board is magnetically drawn to the first magnetic insert of the calendar support thereby tightly securing some of the pages of the paper calendar between the hinged magnetic board and the first magnetic insert leaving at least one of the pages of the paper calendar exposed, and wherein the user can then close the transparent dry erase sheet over top of the exposed page of the paper calendar so that the page is visible to the user, and wherein the user can then elect to either write with a dry erase marker directly onto the transparent, hinged, dry erase sheet over top the expose page or temporarily lift the transparent, hinged, dry erase sheet and write directly onto the exposed page of the paper calendar.
